(19) United States
(12) Patent Application Publication
(10) Pub. No.: US 2005/0175764 A1
(43) Pub. Date: Aug. 11, 2005

(54) Food composition for enhancing endurance

(76) Inventor: Kinya Takagaki, Fukuoka (JP)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/991,670

(22) Filed: Nov. 18, 2004

(30) Foreign Application Priority Data
May 17, 2002 (JP) 2002-143002

(51) Int. Cl. A23K 1/00

(52) U.S. Cl. 426/615

(57) ABSTRACT

The present invention provides a novel food composition for enhancing endurance that comprises proanthocyanidins (A) and lycopene (B). Preferably, the proanthocyanidins contain at least 20 wt % of OPCs.

### BACKGROUND OF THE INVENTION

1. Field of the Invention

The present invention relates to a food composition that comprises proanthocyanidins (A) and lycopene (B).

2. Description of the Related Art

Life in modern society is stressful for many people because of mental strains, anxieties, and the like. Stress disturbs the normal physiological equilibrium and may cause, for example, a reduction in immune strength, and furthermore, may cause obesity, alopecia, and the like. It is also known that stress can cause a reduction in endurance. One common way to relieve such stress is to exercise. However, since people of today are busy and have no time to spare for such exercise, or they are fatigued with daily life, very few of them exercise to relieve stress. Therefore, their endurance is reduced by the stress they have accumulated, and they come to grow fatigued more easily, ant thus, further stress is added.

It seems that in order to avoid such a vicious circle as described above, it is necessary to enhance endurance. The simplest way to enhance endurance is to ingest food having an ability of enhancing endurance. However, no foods suitable for enhancing endurance have been developed yet.

Thus, in order to alleviate stress or in order to exert endurance satisfactorily in situations in which endurance is required, there is a demand for a food that can be ingested easily and is able to enhance endurance.

### SUMMARY OF THE INVENTION

The present invention provides a food composition for enhancing endurance that comprises a proanthocyanidin (A) and lycopene (B).

In one embodiment, the proanthocyanidin is derived from the bark of pine; the fruit or seeds of grape, blueberry, strawberry, avocado, locust, or cowberry; barley; wheat; soybean; black soybean; cacao; the inner skin of peanuts; or the leaves of ginkgo.

In a preferred embodiment, the proanthocyanidin comprises at least 20 wt % of OPC (oligomeric proanthocyanidin).

In one embodiment, the lycopene is derived from tomato, watermelon, pimento, grapefruit, carrot, or apricot, or their extract.

According to the present invention, by ingestion of a food composition that contains proanthocyanidins (A) and lycopene (B), endurance can be enhanced. In particular, when proanthocyanidins that contain at least 20 wt % of OPCs are used, a better effect can be achieved.

### DESCRIPTION OF THE PREFERRED EMBODIMENT

Hereinafter, the food composition for enhancing endurance of the present invention will be described. It should be noted that the following description is not limiting the present invention, and it is apparent to those skilled in the art that various alternations can be made within the scope of the spirit of the present invention.

The food composition for enhancing endurance of the present invention contains proanthocyanidins (A) and lycopene (B). Hereinafter, these components will be described.

(A) Proanthocyanidins

In the present invention, proanthocyanidins refer to a group of compounds that are condensation products having flavan-3-ol and/or flavan-3,4-diol as a constituent unit and having a degree of polymerization of 2 or more. Proanthocyanidins are known to have various activities such as an antioxidation ability.

In this specification, among proanthocyanidins, condensation products having flavan-3-ol and/or flavan-3,4-diol as a constituent unit and having a degree of polymerization of 2 to 4 are referred to as oligomeric proanthocyanidins (OPCs). OPCs, which are one type of polyphenol, are potent antioxidants produced by plants, and contained concentratedly in portions of plant leaves, bark, or skin or seeds of fruits. More specifically, they are contained in the seeds of grape, the bark of pine, the inner skin of peanuts, the leaves of ginkgo, the fruit of locust, and the fruit of cowberry, for example. Moreover, it is known that OPCs are also contained in cola nuts in West Africa; the roots of Rathania in Peru; and Japanese green tea. OPCs cannot be produced in the human body. Proanthocyanidins that contain a large amount of OPCs are preferable.

As the proanthocyanidins contained in the food composition for enhancing endurance of the present invention, foodstuff raw materials such as ground products or extracts obtained from the fruit or seeds of grape, blueberry, strawberry, avocado, and the like can be used. In particular, it is preferable to use a pine bark extract. Among proanthocyanidins, OPCs are especially abundant in pine bark, and thus, a pine bark extract is preferably used as a raw material of the proanthocyanidins in the present invention.

Hereinafter, a method for preparing proanthocyanidins will be described taking a pine bark extract that contains OPCs abundantly as an example.

As the pine bark extract, an extract from the bark of plant belonging to Pinales, such as French maritime pine (Pinus martima), Larix leptolepis, Pinus thunbergii, Pinus densiflora, Pinus parviflora, Pinus pentaphylla, Pinus koraiensis, Pinus pumila, Pinus luchuensis, utsukushimatsu (Pinus densiflora form. umbraculifera), Pinus palustris, Pinus bungeana, and Anneda in Quebec, Canada, can be preferably used. Among these, French maritime pine (Pinus martima) bark extract is preferable.

French maritime pine refers to maritime pines that grow in a part of the Atlantic coastal area in southern France. It is known that the bark of this French maritime pine contains proanthocyanidins, organic acids, and other bioactive substances, and proanthocyanidins from the flavonoid family, which are the main component of the French maritime pine bark, have a potent antioxidation ability of removing active oxygen.

The pine bark extract is obtained by extracting the bark of the above-described pines using water or an organic solvent. When water is used, warm water or hot water can be employed. As the organic solvent that can be employed for extraction, an organic solvent that is acceptable for production of foods or pharmaceuticals can be employed. Examples of such solvent include methanol, ethanol, 1-propanol, 2-propanol, 1-butanol, 2-butanol, butane, acetone, hexane, cyclohexane, propylene glycol, aqueous ethanol, aqueous propylene glycol, methyl ethyl ketone, glycerin, methyl acetate, ethyl acetate, diethyl ether, dichloromethane, edible oils or fats, 1,1,1,2-tetrafluoroethane, and 1,1,2-trichloroethene. The water and the organic solvents may be used alone or in combination. In particular, hot water, aqueous ethanol, and aqueous propylene glycol are preferably used.

The method for extracting proanthocyanidins from pine bark is not particularly limited, and heat extraction or supercritical fluid extraction can be employed, for example.

Supercritical fluid extraction is a method for performing extraction using a supercritical fluid. A supercritical fluid is in a state that is above the liquid-vapor critical point in the phase diagram showing critical temperature and critical pressure. Examples of compounds that can be employed as a supercritical fluid include carbon dioxide, ethylene, propane, and nitrous oxide (laughter gas). Carbon dioxide is preferably used.

Supercritical fluid extraction includes an extraction step in which a target component is extracted with a supercritical fluid and a separation step in which the target component is separated from the supercritical fluid. In the separation step, any separation process can be employed, examples of which include a separation based on a change in pressure, a separation based on a change in temperature, and a separation using an adsorbent or absorbent.

Moreover, it is also possible to perform supercritical fluid extraction in which an entrainer is added. In this method, extraction is performed using an extracting fluid obtained by adding, for example, ethanol, propanol, n-hexane, acetone, toluene, or another aliphatic lower alcohol, aliphatic hydrocarbon, aromatic hydrocarbon, or ketone at about 2 to 20 W/V % to a supercritical fluid, so that the solubility of a target substance to be extracted, such as OPCs and catechins (described later), in the extracting fluid is dramatically increased or the selectivity of separation is enhanced. Thus, a pine bark extract is obtained efficiently.

Since supercritical fluid extraction can be performed at a relatively low temperature, it has the following advantages: it is applicable to substances that deteriorate or decompose at high temperatures; the extracting fluid does not remain; and the extracting fluid can be recovered and recycled, so that a step of removing the extracting fluid and the like can be omitted, and thus, the process can be simplified.

Furthermore, methods other than these mentioned above can be employed for extraction from pine bark, and examples thereof include a batch method using liquid carbon dioxide, a reflux method using liquid carbon dioxide, and a reflux method using supercritical carbon dioxide.

It is also possible to employ a combination of a plurality of extraction processes to perform extraction from pine bark. By combining a plurality of extraction processes, pine bark extracts with various components can be obtained.

The pine bark extract that is used for the food composition for enhancing endurance of the present invention is specifically prepared using the following method. However, this method is merely an example, and the present invention is not limited to this method.

First, 1 kg of the bark of French maritime pine is immersed in 3 L of a saturated solution of sodium chloride, and extraction is performed for 30 minutes at 100° C. to obtain an extract liquid (extraction step). Then, the extract liquid is filtrated, and the resultant insoluble material is washed with 500 ml of a saturated solution of sodium chloride to obtain a washed liquid (washing step). The extract liquid and the washed liquid are combined to obtain a crude extract liquid of pine bark.

Next, 250 ml of ethyl acetate is added to this crude extract liquid, mixed, and separated to obtain an ethyl acetate layer. This process is repeated five times, and the obtained ethyl acetate layers are combined. The resultant ethyl acetate extract is added directly to 200 g of anhydrous sodium sulfate for drying. Then, this ethyl acetate extract is filtrated, and the filtrated extract is concentrated under a reduced pressure to a volume of ⅕ of the original filtrated extract. The concentrated ethyl acetate extract is poured into 2 L of chloroform and stirred, and the resultant precipitate is recovered by filtration. Subsequently, this precipitate is dissolved in 100 ml of ethyl acetate, and then the resultant solution is added to 1 L of chloroform to form a precipitate. This process is repeated twice, and thus, a washing process is accomplished. With this method, for example, about 5 g of pine bark extract containing at least 20 wt % of OPCs that have a degree of polymerization of 2 to 4 and at least 5 wt % of catechins can be obtained.

Extracts from the above-described raw material plants, in particular, pine bark extracts, which are typically used for the proanthocyanidins (A) in the food composition for enhancing endurance of the present invention, contain proanthocyanidins that are condensation products having flavan-3-ol and/or flavan-3,4-diol as a constituent unit and having a degree of polymerization of 2 or more. Extracts that contain a large amount of condensation products having a lower degree of polymerization are preferably used. As such condensation products, condensation products having a degree of polymerization of 2 to 30 (dimer to 30-mer) are preferable, condensation products having a degree of polymerization of 2 to 10 (dimer to decamer) are more preferable, and condensation products having a degree of polymerization of 2 to 4 (dimer to tetramer; i.e., OPCs) are even more preferable.

Since OPCs are antioxidants as described above, they also provide an effect of reducing the possibility of adult diseases, such as cancer, cardiac diseases, and cerebral thrombosis, an effect of improving allergic diathesis, such as arthritis, atopic dermatitis, and pollenosis, and the like.

Furthermore, it is known that in addition to the antioxidation effect, OPCs also provide, for example, an effect of inhibiting bacterial proliferation in the oral cavity to reduce plaque (dental plaque); an effect of recovering the elasticity of blood vessels; an effect of preventing lipoprotein in blood from being damaged by active oxygen, thereby preventing aggregation and adherence of the oxidized fats onto the inside wall of the vessel, thus preventing cholesterol from being aggregated and adhered onto the oxidized fats that have been adhered onto the inside wall of the vessel; an effect of regenerating vitamin E that has been degraded by active oxygen; and an effect of serving as an enhancer of vitamin E.

In the present invention, proanthocyanidins containing at least 20 wt % of OPCs are preferably used. More preferably, the OPC content is at least 30 wt %. As such proanthocyanidins, a pine bark extract is preferably used.

When OPCs from a pine bark extract are used, a better effect of enhancing endurance can be achieved than in the case where proanthocyanidins having a higher degree of polymerization are used.

Moreover, proanthocyanidin contents derived from raw material plants, in particular, plant extracts contain catechins as well as OPCs. The term “catechins” is a general term referring to polyhydroxyflavan-3-ols. As the catechins, gallocatechin, afzelechin, and 3-galloyl derivatives of (+)-catechin or gallocatechin are isolated from natural products, in addition to (+)-catechin that is called catechin in a narrow sense. As the catechins, for example, (+)-catechin, (−)-epicatechin, (+)-gallocatechin, (−)-epigallocatechin, epigallocatechin gallate, and epicatechin gallate are known. Catechins are known to have a cancer inhibiting ability, an arteriosclerosis preventing ability, a lipid metabolism disorder inhibiting ability, a blood pressure elevation inhibiting ability, thrombosis preventing ability, an antiallergic ability, an antiviral ability, an antibacterial ability, a dental caries preventing ability, a halitosis preventing ability, an intestinal flora normalization ability, an active oxygen or free radical eliminating ability, an antioxidation ability, and the like. Moreover, catechins are known to have an antidiabetic ability of inhibiting an elevation of blood glucose. Furthermore, catechins have the property of both increasing the solubility in water and being activated in the presence of OPCs.

It is preferable that catechins are contained in the above-described raw material plant extract in a ratio of 5 wt % or more. Alternatively, it is also preferable that a formulation is prepared so that it contains a raw material plant extract containing at least 20 wt % of OPCs, and furthermore, contains catechins in a ratio of 5 wt % or more. For example, when the catechin content in a pine bark extract is less than 5 wt %, it is possible to add catechins so that the catechin content becomes at least 5 wt %. It is most preferable to use a pine bark extract containing at least 5 wt % of catechins and at least 20 wt % of OPCs.

(B) Lycopene

The food composition for enhancing endurance of the present invention contains lycopene.

Lycopene is a carotenoid that exists in a wide range of animals and plants. Among carotenoids, lycopene shows a high antioxidation activity. Furthermore, among fat-soluble antioxidants, lycopene has a high activity comparable to that of vitamin E and prevents oxidation of lipids in cell membranes and lipids in lipoproteins. Moreover, lycopene is known to also exist in the human body. Similar to the case of beta-carotene, lycopene is present in various tissues. Especially, licopene has a specific character of being distributed in the testis. It seems that the effect of enhancing endurance of the food composition of the present invention is associated with the fact that lycopene exhibits a strong antioxidative ability in the testis.

For the lycopene that is used for the food composition for enhancing endurance of the present invention, food materials that contain lycopene abundantly can be employed. Examples of such food materials that contain lycopene abundantly include, but are not limited to, food materials that contain a red pigment abundantly, such as tomatoes, watermelons, carrots, red pimentos, red grapefruits, and apricots. Even vegetables that contain a rather small amount of lycopene can be employed for the food composition of the present invention by processing them into concentrates (e.g., powdered extracts).

The food composition for enhancing endurance of the present invention comprises the proanthocyanidins (A) and the lycopene (B) at a weight ratio of preferably 1:0.01 to 1:20 and more preferably 1:0.05 to 1:10.

The food composition for enhancing endurance of the present invention comprises the above-described proanthocyanidins (A) and lycopene (B) and comprises a variety of types of additives that are commonly used for foods, if necessary. Examples of such additives include excipients, extenders, binders, thickeners, emulsifiers, coloring agents, flavors, and food additives. For example, the food composition of the present invention may be produced in the form of, for example, tablets or pills by adding an excipient and the like to a mixture of a pine bark extract that contains proanthocyanidins abundantly and a dry powder of tomato juice, or it may be produced in the form of powder or in other forms without being shaped.

It is also possible to be made into the forms of capsules such as hard capsules and soft capsules, powder, granule, tea bags, candy, liquid, and paste.

Furthermore, nutritions such as royal jelly, vitamins, proteins, calcium substances such as eggshell calcium, chitosan, lecithin, chlorella powder, Angelica keiskei powder, and molokheiya powder, also can be added. It is also possible to add stevia powder, ground green tea powder, lemon powder, honey, maltitol, lactose, sugar solutions, seasoning agents, and the like so as to control taste.

Regarding the method for ingesting the food composition for enhancing endurance of the present invention, there is no particular limitation. According to the form of the food composition of the present invention or according to the preference, the food composition may be eaten or drunk as it is, or may be dissolved in water, hot water, milk, or the like and drunk. Alternatively, a liquid containing the components of the food composition obtained by percolation may be drunk.

Although there is no limitation regarding the daily intake amount of the food composition for enhancing endurance of the present invention, it is preferable that the daily intake amount of proanthocyanidins is 20 mg to 2000 mg, and the daily intake amount of lycopene is 1 mg to 500 mg. When food materials that contain these components are used, these materials can be contained in the food composition in any suitable ratio, based on the proanthocyanidin content and the lycopene content.

It seems that the food composition for enhancing endurance of the present invention can achieve the effect of enhancing endurance because of some interaction between the proanthocyaninidins (A) and the lycopene (B).

### EXAMPLE

Hereinafter, the present invention will be described by way of an example. However, the present invention is not limited to this example.

### Example 1

First, an ethanol extract of pine bark (trade name: Flavangenol, produced by TOYO SHINYAKU Co., Ltd.) containing 40 wt % of proanthocyanidins (OPC content: 20 wt % in the extract) and 5 wt % of catechins and lycopene (produced by SIGMA) were mixed so that the weight ratio of the proanthocyanidins and the lycopene was 1:0.1. The resultant mixed powder was referred to “Food 1”.

Then, 0.52 g of the Food 1 was suspended in 4 ml of olive oil to obtain a suspension of the Food 1, and the effect of enhancing endurance was evaluated in the following manner. First, the suspension of the Food 1 was compulsorily administered orally to a group of five male ddy mice at the age of five weeks at a dose of 4 ml/kg body weight once a day for 14 days. The amounts of the ethanol extract of pine bark and the lycopene administered were as shown in Table 1. Then, a forced swimming test was performed 30 minutes after the last administration on day 14. In the forced swimming test, a water bath having a diameter of 32 cm and a depth of 30 cm was provided, and water was placed in the bath. This was stirred to make a water flow with a velocity was of 4 to 8 m/min. The mice were forced to swim, and the maximum swimming time was measured. Table 2 shows the results.

### Comparative Examples 1 and 2

“Food 2” and “Food 3” were prepared, each of which containing either the ethanol extract of pine bark or the lycopene in Example 1. As in Example 1, these foods were suspended in olive oil, and the suspensions were administered to mice, and then the effect of enhancing endurance was evaluated in the forced swimming test. The amounts of the ethanol extract of pine bark and the lycopene administered were as shown in Table 1. Furthermore, mice to which only olive oil was administered instead of the test feeds served as a control group. In all groups, the olive oil suspensions or the olive oil was administered to the mice at a dose of 4 ml/kg body weight. Table 2 also shows the results.

TABLE 1

| | | Com. | Com. | |
|---|---|---|---|---|
| | Ex. 1 | Ex. 1 | Ex. 2 | Control |
| Ethanol extract | 500 | 500 | — | — |
| of pine bark | | | | |
| Lycopene | 20 | — | 20 | — |

The unit of the values is mg/kg body weight/day.

TABLE 2

| | Ex. 1 | Com. Ex. 1 | Com. Ex. 2 | Control |
|---|---|---|---|---|
| Swimming time | 171 ± 7.1 | 146 ± 8.0 | 141 ± 8.0 | 134 ± 8.5 |
| (min.) | | | | |

The values indicate average value ± standard error in each group.

Referring to the results shown in Table 2, it was found that in the case of the food containing both the proanthocyanidins and the lycopene, the swimming time was more prolonged and the endurance was more enhanced than in the cases of the foods containing either of the components alone. In other words, it was shown that the food composition of the present invention provides the effect of enhancing endurance.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

1. A food composition for enhancing endurance, comprising a proanthocyanidin (A) and lycopene (B).

2. The food composition for enhancing endurance of claim 1, wherein the proanthocyanidin is derived from a bark of pine; a fruit or seeds of grape, blueberry, strawberry, avocado, locust, or cowberry; barley; wheat; soybean; black soybean; cacao; an inner skin of peanuts; or leaves of ginkgo.

3. The food composition for enhancing endurance of claim 1, wherein the proanthocyanidin comprises at least 20 wt % of OPC (oligomeric proanthocyanidin).

4. The food composition for enhancing endurance of claim 1, wherein the lycopene is derived from tomato, watermelon, pimento, grapefruit, carrot, or apricot, or their extract.
